(19) United States
(12) Patent Application Publication
(10) Pub. No.: US 2006/0050437 A1
(43) Pub. Date: Mar. 9, 2006

(54) Recording disk cartridge

(75) Inventors: Hideaki Shiga, Odawara (JP); Kengo Oishi, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/210,657

(22) Filed: Aug. 25, 2005

(30) Foreign Application Priority Data
Sep. 9, 2004 (JP) 2004-262048

(51) Int. Cl. G11B 23/03

(52) U.S. Cl. 360/133

(57) ABSTRACT

In a recording disk cartridge, a plurality of flexible recording disk media is housed in a cartridge case, and a rotational member is provided to support the plurality of flexible recording disk media and cause them to rotate in unison within the cartridge case. The cartridge case has an opening to provide access to a first end of the rotational member from outside therethrough. A supporting shaft fitted to a portion on an axis of rotation of the rotational member near a second end thereof is slidable along the axis of rotation of the rotational member. A bearing ball is held between an inner surface of the cartridge case and an end of the supporting shaft protruding from a second-end face of the rotational member. An elastic member is provided between the supporting shaft and the rotational member, to press the rotational member toward the opening of the cartridge case.

### CROSS-REFERENCE TO RELATED APPLIATIONS

This application claims the foreign priority benefit under Title 35, United States Code, § 119 (a)-(d), of Japanese Patent Application No. 2004-262048, filed on Sep. 9, 2004 in the Japan Patent Office, the disclosure of which is herein incorporated by reference in its entirety.

### BACKGROUND OF THE INVENTION

1. Field of the Invention

The present invention relates to a recording disk cartridge comprising a plurality of flexible recording disk media.

2. Description of the Related Art

Conventionally, as a recording disk medium a flexible recording disk medium is known where a magnetic layer is formed on both faces of a disc-form support body consisting of a flexible material such as a polyester sheet. Although the magnetic disk medium has a merit of speedily accessing data in comparison with a magnetic tape, on the other hand, it has a demerit of a memory capacity being small because a recording area thereof is small.

In order to solve the demerit of the flexible magnetic disk medium, it is conventionally disclosed a magnetic disk cartridge for housing a plurality of magnetic disk media in one cartridge case (for example, see JP 2004-22011A). This technique introduces magnetic attraction produced by a spindle of a magnetic disk drive, which acts on an end of the lowermost of center cores that collectively support the plurality of magnetic disk media at their central holes, thereby providing a simultaneous rotation for each magnetic disk medium. In this way, it is possible to improve speed of data transmission by accessing the plurality of magnetic disk media with a plurality of magnetic heads, respectively.

However, the magnetic disk cartridge disclosed in JP 2004-22011 A has a drawback that rotation of the recording disk media falls unstable when their axial distance increases according to their number. The reason for this is attributed to the fact that only the one end of the center core is magnetically attracted by the spindle.

The present invention has been brought about in an effort to provide a recording disk cartridge which is able to provide stable rotation for recording disk media even if their number is increased.

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

### SUMMARY OF THE INVENTION

It is an aspect of the present invention to provide a recording disk cartridge, which comprises: a plurality of flexible recording disk media; a cartridge case for housing the plurality of flexible recording disk media; a rotational member for supporting the plurality of flexible recording disk media and causing the plurality of flexible recording disk media to rotate in unison within the cartridge case, the rotational member having axially opposed first and second ends, wherein the cartridge case has an opening to provide access to the first end of the rotational member from outside therethrough; a supporting shaft fitted to a portion on an axis of rotation of the rotational member near the second end thereof, the supporting shaft being slidable along the axis of rotation of the rotational member; a bearing ball held between an inner surface of the cartridge case and an end of the supporting shaft protruding from a second-end face of the rotational member; and an elastic member provided between the supporting shaft and the rotational member, the elastic member being stressed to press the rotational member toward the opening of the cartridge case.

According to the arrangement defined above, the rotational member is pressed toward the opening of the cartridge case by the elastic member provided between the rotational member and the supporting shaft that is supported on the bearing ball which is in turn supported on the inner surface of the cartridge case. Therefore, when a spindle of a disk drive enters the cartridge case through the opening thereof and engages with the first end of the rotational member, the elastic member presses the rotational member onto the spindle. This causes the rotational member and the spindle to be engaged firmly, and thus serves to stabilize rotation of the plurality of flexible recording disk media even in cases where the number of flexible recording disk media provided in the recording disk cartridge is increased. Further, once the rotational member is engaged with and supported by the spindle, the elastic member not only presses the rotational member toward the opening of the cartridge case but also presses the supporting shaft, and then the bearing ball, toward the inner surface of the cartridge case; thus, the center of rotation of the rotational member (i.e., of each flexible recording disk medium) is fixedly established at a contact position between the bearing ball and the inner surface of the cartridge case, and wobbling of the rotational member is restricted, with the result that the rotary motion of the rotational member can be stabilized further.

The above supporting shaft may be fitted in an insertion hole provided in the rotational member. Alternatively, the above supporting shaft may be fitted on a sliding shaft provided in the rotational member.

In the above recording disk cartridge, a ball holding portion having a surface recessed to form a substantially cylindrical hollow to rotatably hold the bearing ball may be provided at the end of the supporting shaft. Alternatively, a ball holding portion having a surface recessed to form a substantially cylindrical hollow to rotatably hold the bearing ball may be provided at the inner surface of the cartridge case.

The ball holding portion may preferably but not necessarily have a depth equal to or greater than a radius of the bearing ball and less than a diameter of the bearing ball. This ensures secure holding of the bearing ball while allowing part of the bearing ball to protrude beyond an edge of the opening of the ball holding portion.

The substantially cylindrical hollow may be defined with at least one inner cylindrical wall of the ball holding portion, and at least one inwardly protruding stopper portion may be provided on the at least one inner cylindrical wall to prevent the bearing ball from coming away from the ball holding portion. Thanks to the stopper portion as defined above, the bearing ball never comes away from the ball holding portion even when the recording disk cartridge is on an assembly line, and thus an assembly work therefor can be facilitated. More specifically, the inwardly protruding stopper portion may be designed in such a manner that a diameter of an inscribed circle defined by an innermost edge of the stopper portion is less than a diameter of the bearing ball. An edge of the at least one inner cylindrical wall adjacent to an opening of the substantially cylindrical hollow may preferably but not necessarily be chamfered.

The above stopper portion may be designed to slope outside toward an opening of the substantially cylindrical hollow. The stopper portion as thus sloped outside facilitates fitting of the bearing ball into the ball holding portion, because the bearing ball brought into contact with a sloped surface of the stopper portion pushes at least one inner cylindrical wall of the ball holding portion outward to make the opening of the ball holding portion wider when the bearing ball is fitted into the ball holding portion.

The elastic member may be comprised of a compression coil spring. Alternatively, the elastic member may be comprised of a Belleville spring.

In the above recording disk cartridge, an abrasion-resistant member may further be provided on at least one of contact portions between the end of the supporting shaft and the bearing ball and between the bearing ball and the inner surface of the cartridge case. The abrasion-resistant member serves to reduce abrasion of the supporting shaft, bearing ball and cartridge case, thus enhancing the durability thereof.

In one embodiment, the above rotational member may be comprised of center cores provided respectively in the plurality of flexible recording disk media, which center cores are stacked in a manner that permits no relative rotation of the plurality of flexible recording disk media. In this construction, by stacking the center cores provided respectively in the plurality of flexible recording disk media, the recording disk cartridge can be assembled, and thus the number of recording disk media can be changed merely by increasing or decreasing the number of units each comprised of a recording disk medium and a center core to be assembled.

Alternatively, the rotational member may be comprised of a hub, at least one spacer ring, and a clamper. The hub has a bottomed cylinder and a flange extending outward from a periphery of the bottomed cylinder. The at least one spacer ring is each provided between adjacent two of the plurality of flexible recording disk media. The damper has a columnar portion to be fitted inside the bottomed cylinder of the hub, and a flange extending outward from a periphery of the columnar portion. The plurality of flexible recording disk media and the at least one spacer ring are held between the flanges of the hub and the clamper. The flanges of the hub and the clamper, the plurality of flexible recording disk media, and the at least one spacer ring are fixed in a manner that permits no relative rotation of each other.

The ball holding portion may be designed to have a bottom surface (defining the substantially cylindrical hollow) that is a curved surface of which a portion in contact with the bearing ball has a radius of curvature greater than that of the bearing ball.

The recording disk cartridge consistent with the present invention includes a magnetic disk cartridge containing a plurality of magnetic disk media, and an optical disk cartridge containing a plurality of optical disk media.

The above aspects, other advantages and further features of the present invention will become readily apparent from the following description of illustrative, non-limiting embodiments thereof with reference to the accompanying drawings.

### BRIEF DESCRIPTION OF THE DRAWINGS

FIG. 1 is an exploded perspective view of a magnetic disk cartridge related to an embodiment of the present invention.

FIG. 2A is an external perspective view of a magnetic disk cartridge with a shutter closed related to an embodiment of the present invention; FIG. 2B is an external perspective view with the shutter opened related to the magnetic disk cartridge.

FIG. 3 is a perspective view showing an inner face of an upper plate.

FIG. 4 is a section view taken along a line IV-IV in FIG. 2B of the magnetic disk cartridge loaded on a magnetic disk drive.

FIG. 5 is a partially enlarged drawing of FIG. 4.

FIG. 6 is an exploded perspective view showing a stack structure of magnetic disk media.

FIG. 7 is a sectional view showing another embodiment of the present invention in which a sliding shaft is substituted for a center hole and provided at a portion on an axis of rotation of center cores.

FIG. 8 is a sectional view showing another exemplified embodiment of the present invention with a rotational member comprised of a hub, a spacer ring and a clamper.

FIG. 9 is a sectional view showing another exemplified embodiment of the present invention with a ball holding portion provided on an inner surface of an upper plate.

FIG. 10 is an enlarged section of the ball holding portion shown in FIG. 9 having a stopper portion formed therein.

FIG. 11 is an enlarged sectional view of the ball holding portion shown in FIG. 10 having a tapered portion formed therein.

FIG. 12A is an enlarged perspective view of a ball holding portion formed with two support walls; and FIG. 12B is a sectional view taken along line X-X of FIG. 12A.

FIGS. 13A and 13B are enlarged sectional views of a ball holding portion with a curved bottom surface, in which the bottom surface in FIG. 13A is spherically recessed, and the bottom surface in FIG. 13B is spherically bulged.

### DETAILED DESCRIPTION OF THE EXEMPLARY EMBODIMENTS

Here will be described an embodiment of the present invention in detail, referring to drawings as needed. In the embodiment will be described a case of adopting a magnetic disk medium as an example of a recording disk medium.

Meanwhile, in a description below, with respect to up/down directions, making it a standard a typical use state of the magnetic disk cartridge, vertical directions for faces of magnetic disk media are called the up/down directions for convenience.

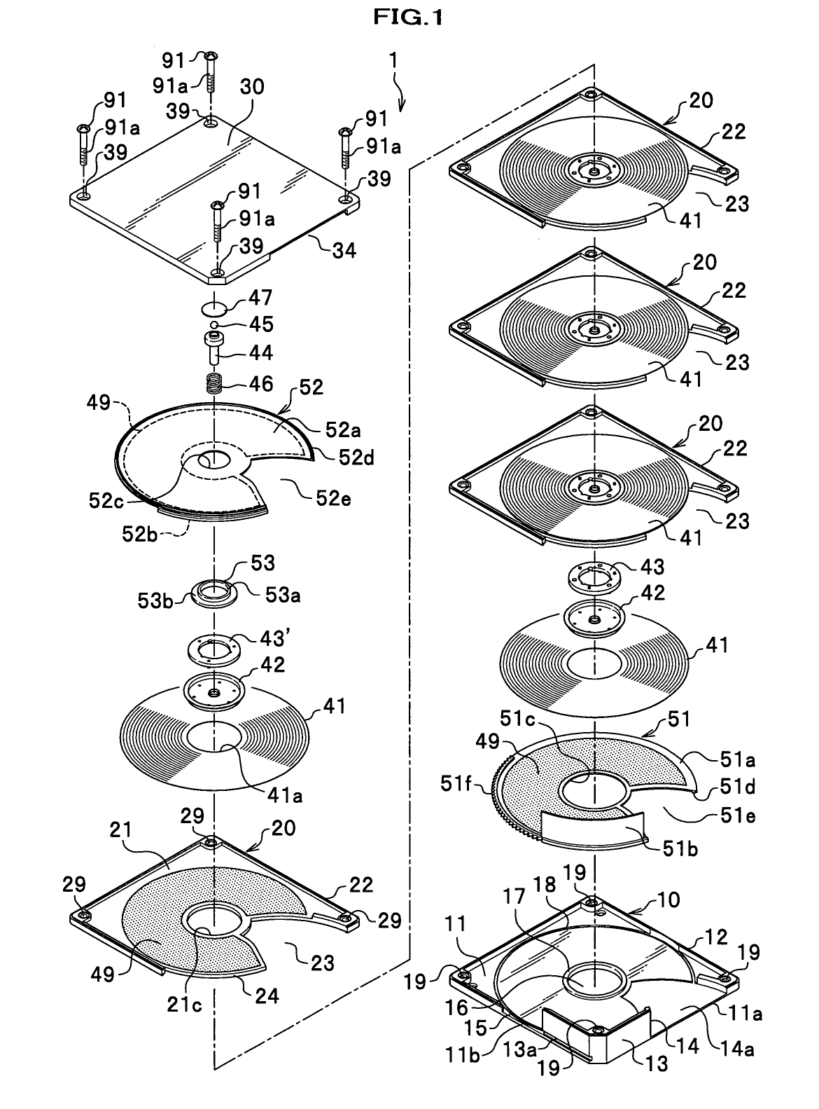

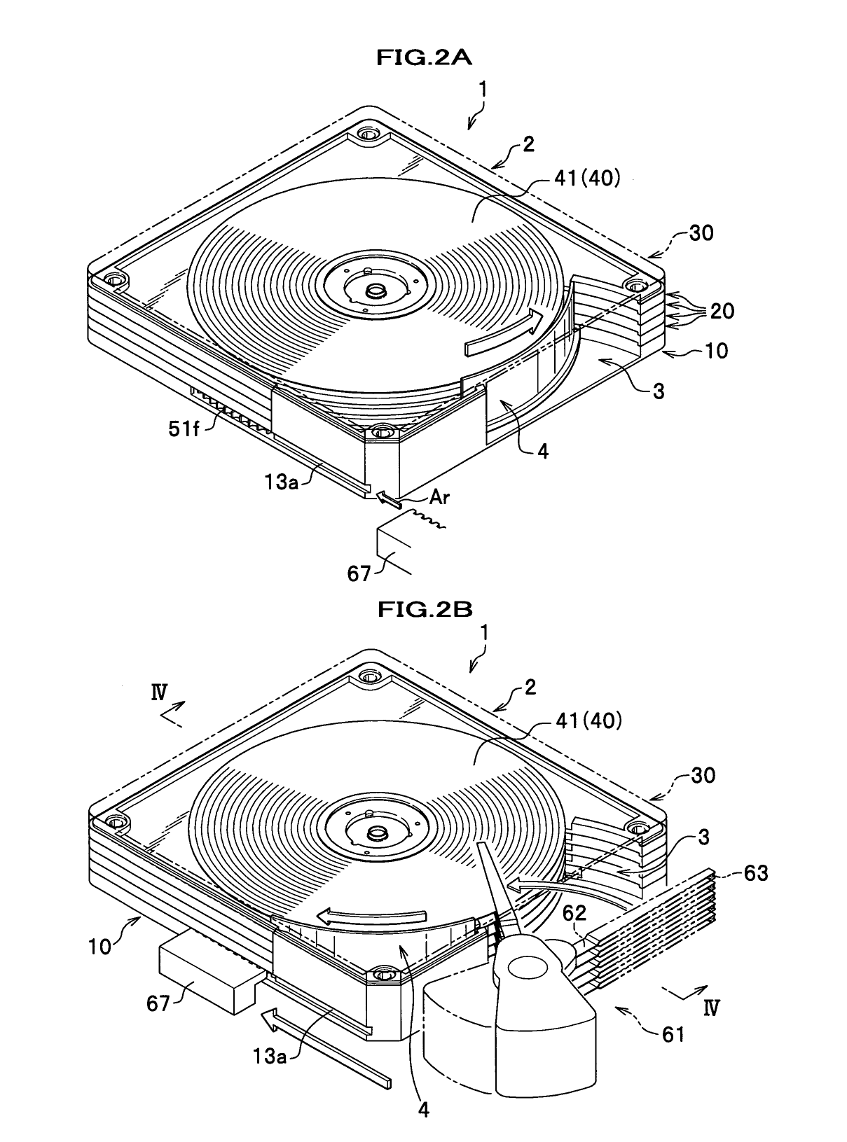

As shown in FIG. 1, in a magnetic disk cartridge 1 of an example of a recording disk cartridge are stacked a lower plate 10 for configuring a lower wall thereof; a plurality of, for example, four inner plates 20, and an upper plate 30 for configuring an upper wall thereof in this order; these are fastened and fixed with four screws 91; and thereby a cartridge case 2 (see FIG. 2A) is configured. Between the lower plate 10 and the lowermost inner plate 20, between any adjacent two of the four inner plates 20, and between the uppermost inner plate 20 and the upper plate 30 is arranged a magnetic disk medium 41, respectively. Each magnetic disk medium 41 is a disc form having an opening 41a at center thereof, and a center core (rotational member) 42 made of metal is affixed at rim of the opening 41a. It is designed that any adjacent two center cores 42 are engaged by spacers (rotational member) 43, 43′, and that five magnetic disk media 41 (the magnetic disk media 41 stacked and integrated are assumed to be a disk stack 40) are integrally rotated.

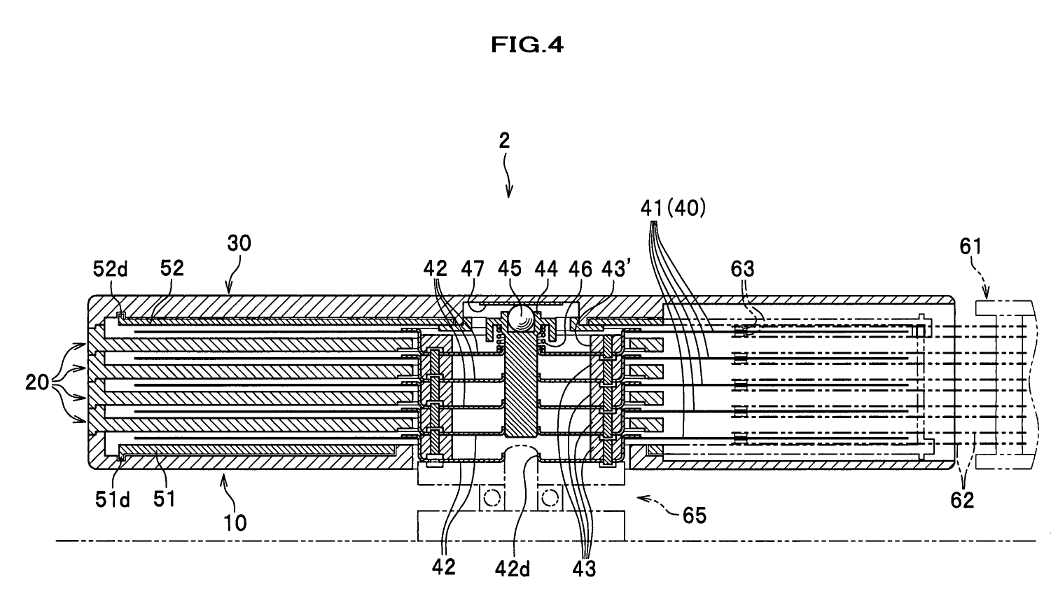

In each of the inner plates 20 is formed a rib 22 for abutting with upper/lower plates at a peripheral rim of a flat main plate 21. Part of a right near side of each of the inner plates 20 in FIG. 1 forms a notch 23 so that magnetic heads 63 (see FIG. 4) can easily move onto the magnetic disk media 41. At the portion of the notch 23 is not formed the rib 22, and therefore, when the inner plates 20 are stacked up, an opening 3 is formed on a side face of the cartridge case 2 as shown in FIG. 2A.

The opening 3 is opened/closed by a shutter 4 that coaxially rotates with the disk stack 40. As shown in FIG. 1, the shutter 4 is configured by combining a lower rotor 51 and an upper rotor 52.

Next will be described each member in more detail.

The lower plate 10 is designed at a peripheral rim of a main plate 11 of a substantially square to mainly form a side wall 13 and a rib 12 for abutting with a lower face of the rib 22 of the lowermost inner plate 20. The side wall 13 is vertically provided in a predetermined range, for example, around one third range of one edge, from one corner of the main plate 11 (near side corner in FIG. 1), and is formed approximately in height of the inner plates 20 stacked.

A sector portion toward a center of the main plate 11 from one edge 11a (one edge of right near side in FIG. 1) continuing into the side wall 13 of the main plate 11 is designed to form a depression 14a lowered by one step, not to form the rib 12 at the peripheral rim of the main plate 11, and to become an opening 14. Thus it becomes easy for the magnetic heads 63 to proceed into the cartridge case 2.

An approximately central one third range of the other edge 11b (one edge of left near side in FIG. 1) continuing into the side wall 13 of the main plate 11 is designed not to form the rib 12 but to become an opening 15 so that a gear 51f of the lower rotor 51 described later can be exposed. In addition, outside the side wall 13 of the other edge 11b is formed a groove 13a along a periphery of the lower plate 10, continuing into the opening 15. The groove 13a is designed to be a passage where a shutter open gear 67 (see FIG. 2A) of a magnetic disk drive proceeds in a direction shown in an arrow Ar of FIG. 2A and enters in the opening 15 in order to engage in the gear 51f.

The rib 12 is formed so as to protrude upward across all periphery except the side wall 13 and the openings 14, 15 out of a peripheral rim of the main plate 11. At center of the main plate 11 is formed a circular opening 16 for exposing the center core 42 provided inside the lowermost magnetic disk medium 41. At upper rim of the opening 16, across all periphery thereof is formed a rib 17 outside which a central opening 51c formed at center of the lower rotor 51 fits. The rib 17 rotationally freely supports the lower rotor 51.

In addition, on an upper face (inner face) of the main plate 11 is formed a circular lower rotor support groove 18 at a position corresponding to peripheral rim of the lower rotor 51. The lower rotor support groove 18 rotationally freely supports the lower rotor 51 coaxially with the magnetic disk media 41 by engaging in a rib 51d (see FIG. 4) formed downward at a peripheral rim of the lower rotor 51.

In addition, at four corners of the main plate 11 are formed screw holes 19 where female threads are formed, respectively, with penetrating through the up/down directions.

The main plate 21 of each of the inner plates 20 is substantially a square, and a portion corresponding to one of four corners of the square is designed to be an arc (arc portion 24) one size larger than the magnetic disk medium 41. At one edge (right near side in FIG. 1) continuing into the arc portion 24 is formed the notch 23 into a sector. The rib 22 protrudes the up/down directions and is formed across all periphery except the arc portion 24 and the notch 23 out of periphery rim of the main plate 21. At center of the main plate 21 is formed a central opening 21c for enabling the upper center core 42 to be exposed and to be coupled with the lower center core 42.

In addition, at three corners of the main plate 21, with penetrating through the three corners in the up/down directions, are formed holes 29 through which screw shaft portions 91a of the screws 91 are inserted, respectively.

The upper plate 30 is formed substantially symmetric to the lower plate 10. As shown in FIG. 3, in the upper plate 30, on a substantially square main plate 31 are formed a depression 34 corresponding to the depression 14a, a rib 37 corresponding to the rib 17, and an upper rotor support groove 38 corresponding to the lower rotor support groove 18. Meanwhile, at center of the main plate 31 are not formed an opening and a side wall corresponding to the side wall 13.

In addition, at a peripheral rim of the main plate 31, across all periphery except the depression 34 is formed a rib 32 protruding downward.

In addition, at four corners of the main plate 31 are respectively formed holes 39 that enables the screw shaft portions 91a of the screws 91 to be penetrated therethrough.

The lower rotor 51 is designed so that: a central opening 51c, a notch 51e, a rib 51d, and the gear 51f are formed on a ring-form lower rotor plate 51a substantially same as the magnetic disk media 41; and a shutter plate 51b is vertically provided at the peripheral rim of the lower rotor plate 51a. The central opening 51c is formed as a circle fitting outside the rib 17, the notch 51e is formed as a sector corresponding to the depression 14a. In addition, the rib 51d is provided downward at a peripheral rim of a lower face of the lower rotor plate 51a, corresponding to the lower rotor support groove 18.

The shutter plate 51b is a blocking member for blocking the opening 3 (see FIG. 2A) and the disk stack 40 and is vertically provided along the peripheral rim of the lower rotor plate 51a with neighboring the notch 51e. The gear 51f is an engaged portion for opening/closing the shutter 4 (see FIG. 2A) from outside of the magnetic disk cartridge 1, and is formed at a peripheral rim of the lower rotor plate 51a within a predetermined range with neighboring the shutter plate 51b.

The upper rotor 52 is designed to be substantially symmetric to the lower rotor 51: the upper rotor 52 comprises an upper rotor plate 52a similar to the lower rotor plate 51a; on the upper rotor plate 52a are formed a central opening 52c fitting outside the rib 37 of the upper plate 30, a notch 52e corresponding to the depression 34, and a rib 52d corresponding to the upper rotor support groove 38. In addition, at a portion adjacent to the notch 52e of a peripheral rim of the upper rotor plate 52a is formed a shutter groove 52b, corresponding to the shutter plate 51b of the lower rotor 51. The lower rotor 51 and the upper rotor 52 are designed to integrally rotate by the shutter groove 52b and upper end rim of the shutter plate 51b engaging.

The upper rotor 52 is rotationally freely supported by the upper plate 30 by the central opening 52c fitting outside the rib 37 of the upper plate 30, and the rib 52d engaging in the upper rotor support groove 38. Meanwhile, the upper rotor 52 is prevented from dropping from the upper plate 30 by a stop member 53. The stop member 53 comprises a cylindrical portion 53a inserted in the rib 37 (see FIG. 3) and a flange 53b formed at one end of the cylindrical portion 53a; the cylindrical portion 53a is inserted in the central opening 52c from a lower side of the upper rotor 52 and is fixed at the rib 37 by ultrasonic welding, adhesion, and the like.

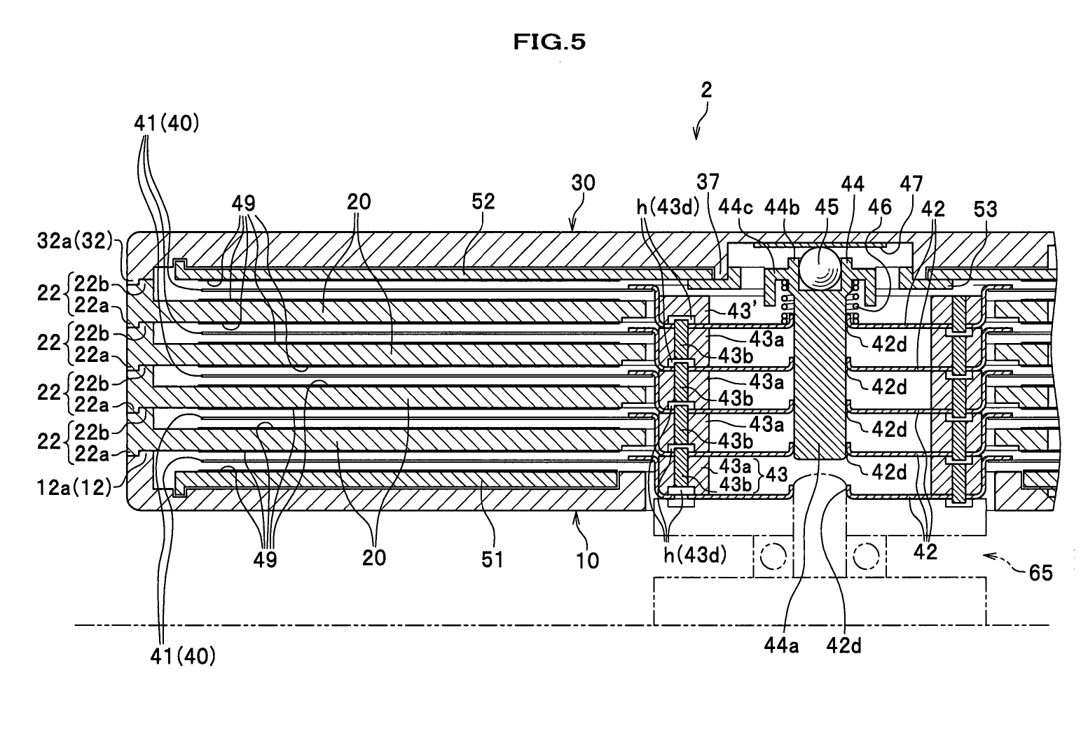

As an enlarged section drawing shown in FIG. 5, an upper face of the lower rotor 51, upper and lower faces of the inner plates 20, and a lower face of the upper rotor 52 are faces opposing the magnetic disk media 41, where liners 49 are affixed across portions opposing the media 41, respectively.

The liners 49 consist of, for example, a non-woven cloth such as a polyester fiber and a blended fabric fiber of rayon and polyester Next will be described a stack structure of the lower plate 10, the inner plates 20, and the upper plate 30.

In the rib 12 of the lower plate 10, as shown in FIG. 5, an inside thereof is formed higher by one step than an outside thereof, and thereby a male type step portion 12a is formed; each rib 22 of the inner plates 20 forms a female type step portion 22a protruding downward at outermost periphery, and thus a periphery of the male type step portion 12a and an inner perimeter of the female type step portion 22a become able to be fitted. In addition, when the lower plate 10, the inner plates 20, and the upper plate 30 are fastened by the screws 91 (see FIG. 1), an upper face of the male type step portion 12a and a corresponding portion of a lower face of the lowermost inner plate 20 are designed to be contacted. Thus, because the rib 12 of the lower plate 10 and the rib 22 of the inner plate 20 are sealingly abutted and fitted each other, an invasion of dust into the cartridge case 2 from outside is prevented.

Similarly, any adjacent two of the inner plates 20, and the uppermost inner plate 20 and the upper plate 30 are stacked by being sealingly abutted and fitted each other. In other words, on an upper face of each of the inner plates 20 is formed a male type step portion 22b where an inside of the upper face is formed higher by one step; at a rib 32 of the upper plate 30 is formed a female type step portion 32a of which outermost periphery protrudes downward by one step. And the male type step portion 22b of one inner plate 20 and the female type step portion 22a of an upper adjacent inner plate 20 are sealingly abutted and fitted each other; the male type step portion 22b of the uppermost inner plate 20 and the female type step portion 32a of the upper plate 30 are sealingly abutted and fitted, and stacked. Thus any adjacent two of the ribs 12, 22, 32 are sealingly abutted and fitted each other, and dust from outside is prevented from invading into the cartridge case 2. In addition, as soon as the lower plate 10, the inner plates 20, and the upper plate 30 are stacked, the side wall 13 of the cartridge case 2 is configured. Furthermore, because the lower plate 10, the inner plates 20, and the upper plate 30 are accurately positioned each other, and respective relative movements go away by being sealingly abutted and fitted each other, a rigidity of the cartridge case 2 improves.

In addition, both of the female type step portion 22a and the male type step portion 22b protrude from the main plate 21 beyond a thickness of the liner 49. Therefore, after affixing the liners 49 on the inner plates 20 and making an assembly, then even if placing it on a work bench, the liners 49 do not contact the work bench, and accordingly, are not contaminated with dust and the like.

Such the configuration of the cartridge case 2 by stacking the inner plates 20 facilitates a change of a number of the magnetic disk media 41; although a height change of the side wall 13 and that of the shutter plate 51b are requested, a number of housing units of the magnetic disk media 41 formed within the cartridge case 2 can be changed only by mainly changing a number of the inner plates 20.

Next will be described the magnetic disk media 41 and a stack structure thereof. The magnetic disk media 41 are ones where magnetic paint is coated on both faces of a resin sheet, for example, such as polyester.

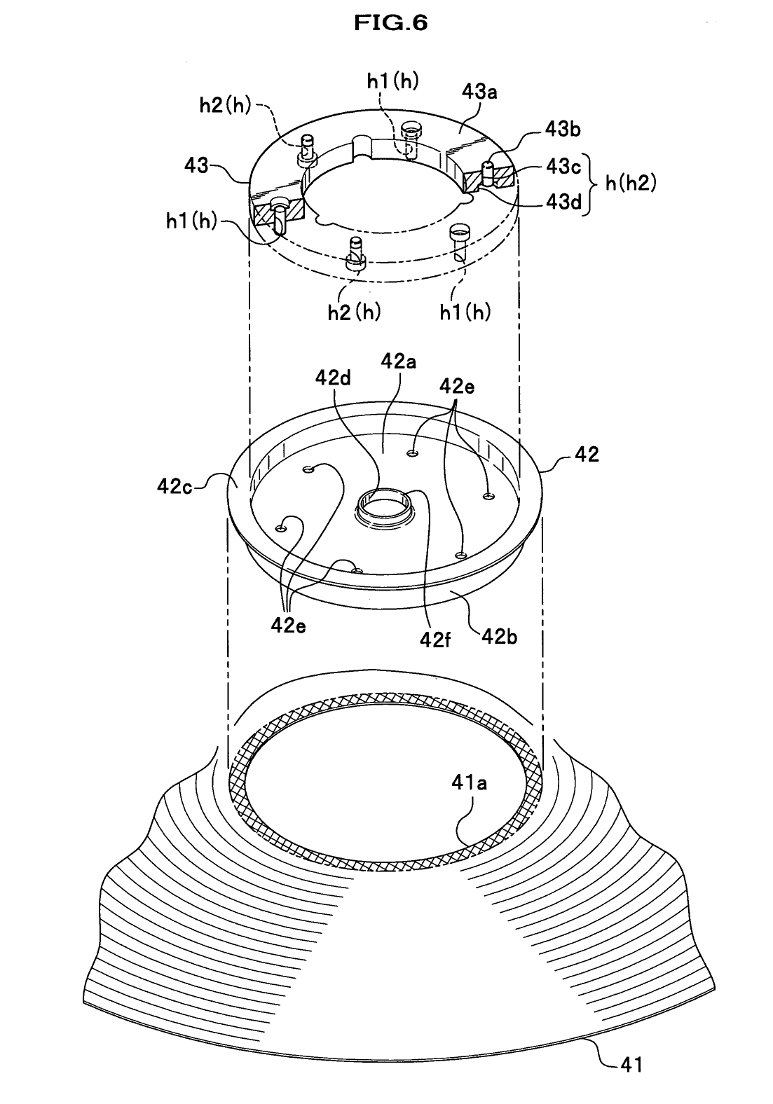

As shown in FIG. 6, each of the center cores 42 is one substantially made a hat form with draw forming a metal plate by press: the center core 42 is mainly configured of a circular bottom plate 42a, a low cylindrical side wall 42b rising from peripheral rim of the bottom plate 42a, and a flange 42c widening in an outer diameter direction from an upper end of the side wall 42b. At center of the bottom plate 42a is formed a center hole 42d, and at rim of the plate 42a are formed six small holes 42e at a distance of 60 degrees, making the center hole 42d a center thereof.

A spacer 43 is provided between adjacent center cores 42, keeps a distance of each of the center cores 42, stops a rotation between each of the center cores 42, and functions so that the stacked magnetic disk media 41 integrally rotate. The spacer 43 is mainly configured of a main body portion 43a shaped like a ring from a resin and metallic pins 43b pressed into the main body portion 43a. In the main body portion 43a are formed six penetration holes h at positions corresponding to the small holes 42e of the center core 42, wherein each of the penetration holes h consists of a small diameter hole portion 43c, where the pin 43b is pressed, and a large diameter hole portion 43d that is coaxial with and slightly larger in diameter than the small diameter hole portion 43c. The six penetration holes h are designed to be upside down in any two adjacent ones. In other words, penetration holes h2 of both adjacent penetration holes h1, where each the large diameter hole portion 43d is positioned at an upper side thereof, are arranged so that the large diameter hole portion 43d is positioned at a lower side thereof.

Into each of the small diameter portions 43c is pressed each one pin 43b from upper/lower sides thereof, one end of the pin 43b is positioned at a boundary of the large diameter hole portion 43d and the small diameter hole portion 43c, and the other end thereof protrudes outside the small diameter portion 43c. The large diameter hole portion 43d serves a function of a clearance at ends of pins 43b of adjacent spacers 43.

As shown in FIG. 5, such the spacers 43 are provided between adjacent center cores 42, respectively. One pin 43b protruding toward a lower side of each of the spacers 43 enters in a small hole 42e of one center core 42 at the lower side of the spacer 43, and stops a rotation relative to the center core 42 at the lower side. If there is another spacer 43 at a still lower side than the center core 42 at the lower side, a floating-up of the spacer 43 for the center core 42 is prevented by the pin 43b entering the large diameter hole portion 43d in the spacer 43 at the lower side. The other pin 43b protruding toward an upper side of the spacer 43 enters in a small hole 42e of the other center core 42 at the upper side of the spacer 43, and stops a rotation relative to the center core 42 at the upper side. If there is another spacer 43 at a still upper side than the center core 42 at the upper side, the top end of the pin 43b enters in the large diameter hole portion 43d in the spacer 43 at the upper side.

Meanwhile, because at an upper side the uppermost center core 42 has no center core 42 to stop a rotation thereof, at the upper side is arranged a thin top spacer 43′ in thickness where the pin 43b is protruded only downward.

The magnetic disk media 41 thus stacked, namely, the disk stack 40, are stably supported in rotation by a coupling shaft (supporting shaft) 44, a bearing ball 45, a compression coil spring (elastic member) 46, and a center plate 47.

As shown in FIG. 5, the coupling shaft 44 lessens a central fluctuation between the center cores 42 stacked, holds the bearing ball 45 and the compression coil spring 46, and comprises a shaft portion 44a, a ball holding portion 44b, and a spring holding portion 44c. The shaft portion 44a is a columnar form that can be inserted through the center holes 42d of the center cores 42. The shaft portion 44a is slidably inserted in the center holes 42d (more specifically speaking, a flange 42f projecting upward around the center hole 42d, as shown in FIG. 6) At an upper end of the shaft portion 44a the ball holding portion 44b is formed into a cylindrical form with a bottom opening to an upper side thereof. Because a depth of the ball holding portion 44b is larger than a radius of the bearing ball 45 and smaller than its diameter, the bearing ball 45 is not only stably held at the ball holding portion 44b but also in point-contact with the center plate 47 on the upper plate 30. The spring holding portion 44c consists of a form where a cylindrical form with a bottom is turned down at a side of an outer diameter of the ball holding portion 44b, and the compression coil spring 46 is arranged in a cylindrical space between the shaft portion 44a and the spring holding portion 44c. Meanwhile, although a length of the coupling shaft 44 is arbitrary, in the embodiment it is one reaching the second center core 42 from the lowermost one; the center hole 42d of the lowermost center core 42 is opened so that a spindle 65 of a magnetic disk drive can proceed.

The center plate 47 is a slide member (abrasion-resistant member) affixed at the center of an inner face of the upper plate 30, that is, on a flat face of an inside of the rib 37. The center plate 47 can be composed of, for example, a material excellent in sliding ability and abrasion resistance such as polyoxymethylene and ultra high molecular weight polyethylene.

Although the bearing ball 45 consists of a sphere made of, for example, steel used for a ball bearing, it may also be composed of a material excellent in sliding ability and abrasion resistance, for example, such as polytetrafluoroethylene, polyoxymethylene, polyamide (PA), polyamide-imide (PAI), polyether ether ketone (PEEK), polyether ketone (PEK), polyetherimide (PEI), polycarbonate (PC). The bearing ball 45 is arranged within the ball holding portion 44b of the coupling shaft 44, abuts with the bottom face of the ball holding portion 44b; and a center of an inner face of the upper plate 30, that is, the center plate 47 by a point contact, and rotationally supports the disk stack 40.

In the compression coil spring 46 one end (upper end) is held by the spring holding portion 44c of the coupling shaft 44; the other end (lower end) abuts with an upper face of the uppermost center core 42, and energizes the stacked center cores 42 to the side of the lower plate 10, that is, to the side of the spindle 65 of the magnetic disk drive. Thus the center cores 42 do not jounce within the cartridge case 2, and the fluctuation of the magnetic disk media 41 is prevented in rotation thereof. The compression coil spring 46 downwardly presses (urges) the stacked center cores 42; the stacked center cores 42, which are supported by the lower plate 10 or the spindle 65, in turn, continuously presses the coupling shaft 44 toward the upper plate 30. As a result, the bearing ball 45 is continuously in contact with the center plate 47.

A magnetic disk drive for recoding/reproducing data for the magnetic disk cartridge 1 rotates, as shown in FIG. 4, the disk stack 40 by the spindle 65. The spindle 65 attracts the lowermost center core 42 by magnetic force, enters in the center hole 42d of the center core 42, and thereby matches an axis thereof with that of the disk stack 40. At this time, because the spindle 65 slightly lifts up the center cores 42 with resisting an energizing force of the compression coil spring 46, as shown in FIGS. 4 and 5, each of the magnetic disk media 41 is positioned at center of a space formed between the lower rotor 51 and the lowermost inner plate 20, between upper and lower inner plates 20, and between the uppermost inner plate 20 and the upper rotor 52. The magnetic heads 63 are provided at top ends of swing arms 62. Each of the magnetic heads 63 is arranged on both faces of each of the magnetic disk media 41.

The magnetic disk cartridge 1 thus described can prevent, in no use thereof as shown in FIG. 2A, an invasion of dust thereto by closing the opening 3 with rotating the shutter 4 in a counterclockwise direction of the drawing; in use thereof as shown in FIG. 2B, when loaded on the magnetic disk drive, the shutter open gear 67 fits in the groove 13a, is guided thereby, engages in the gear 51f, and rotates the shutter 4 in a clockwise direction of the drawing.

As shown in FIG. 5, when the spindle 65 goes upward so as to magnetically attract the lowermost center core 42, the disk stack 40 is lifted to some extent by the spindle 65. Because this leads to further compression of the compression coil spring 46, which is set to be compressed in advance, the center core 42 is pressed with an appropriate pressure exerted by the spindle 65, so that the center core 42 is tightly engaged with the spindle 65. At the same time, because the coupling shaft 44 is also pressed with an appropriate pressure by the compression coil spring 46 toward the upper plate 30, the bearing ball 45 is able to be in good contact with the center plate 47.

When the spindle 65 engaged with the lowermost center core 42 as described above is rotated, the disk stack 40 stably rotates about a point contact between the bearing ball 45 and the center plate 47. Subsequently, the swing arms 62 driven by an actuator 61 make swing motion so as to place the magnetic heads 63 on the magnetic disk media 41.

When recording data on the magnetic disk media 41 with the magnetic heads 63, the data is recorded thereon by sending a signal to the magnetic heads 63 by a control circuit not shown; when reproducing data from the magnetic disk medium 41, a signal is output by detecting a change of a magnetic field on the medium 41 with the magnetic heads 63a.

At this time, dust on the magnetic disk media 41 is removed by the liners 49 appropriately touching respective media 41.

After the use of the magnetic disk cartridge 1, the magnetic heads 63 are retracted from the cartridge case 2, thereafter ejects the magnetic disk cartridge 1; thereby the gear 51f is driven by the shutter open gear 67, and the shutter 4 closes the opening 3.

As described above, the embodiment of the present invention brings about the following advantages.

Because the compression coil spring 46 presses the center core 42 against the spindle 65 of the magnetic disk drive, which enters the opening 16, the center core 42 is tightly engaged with the spindle 65. In this way, it is possible to stabilize rotation of the magnetic disk media 41, even if their number of the magnetic disk media 41 is increased to five as shown in the embodiment described above.

When the center core 42 is supported by the spindle 65, the compression coil spring 46 presses not only the center core 42 but also the coupling shaft 44 (bearing ball 45) against the cartridge case 2. This provides a center of rotation for the disk stack 40, thereby further stabilizing rotation of the disk stack 40.

Because the center plate 47 as an abrasion-resistant member is introduced, it is possible to provide better durability of the cartridge case 2 by restriction of its abrasion, in comparison with another cartridge case 2 which is in direct contact with a bearing ball 45.

Thus because the magnetic disk cartridge 1 has a plurality of the magnetic disk media 41, data transfer can be performed at a higher speed by simultaneously accessing data with a plurality of magnetic heads 63.

In addition, because the cartridge case 2 is configured by stacking up the inner plates 20, it is easy to perform a specification change of making a number of magnetic disk media 41 a different one. Then, in assembling the magnetic disk cartridge 1, because the magnetic disk media 41 can be handled with being placed on the inner plates 20 and the lower rotor 51 built in the lower plate 10, an occasion of touching the magnetic disk media 41 can be reduced and a quality of the cartridge 1 can be further stablized.

In addition, because each of the inner plates 20 is stacked on the lower plate 10 or another inner plate 20 and is fixed, the magnetic disk cartridge 1 can make it higher a parallelism to the magnetic disk media 41, can stabilize a rotation of the media 41, and enable a higher speed rotation of the media 41, furthermore a higher speed of a data transfer.

Thus, although the embodiment of the present invention is described, the invention is not limited thereto and can be embodied with being changed as needed. For example, although in the embodiment the magnetic disk medium 41 is applied to a recording disk medium, an optical recording medium where data is recorded by light can also be applied thereto.

In addition, although in the embodiment the lower plate 10, the inner plates 20, and the upper plate 30 are fastened and fixed by the screws 91, they can also be integrally fixed by any of adhesion and deposition.

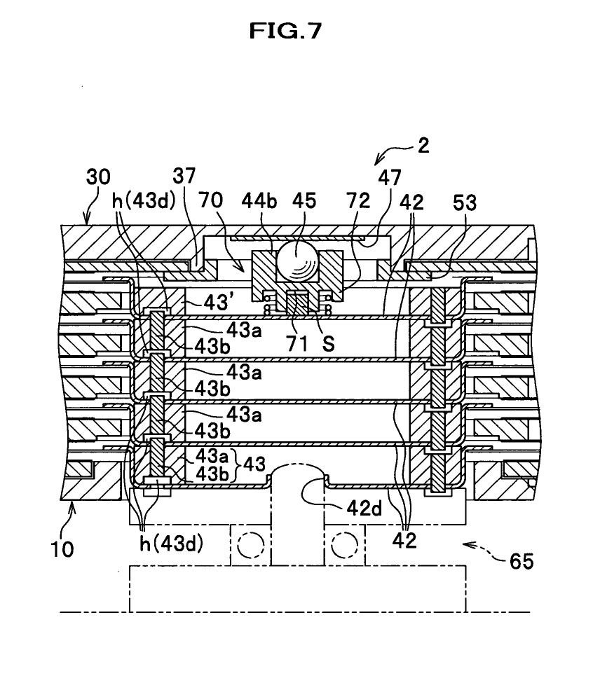

The recording disk cartridge according to the embodiment described above has the coupling shaft 44 which is inserted through the center hole 42d so as to be slidable relative to the center cores 42. The invention is not limited to this. As shown in FIG. 7, for example, it may be alternatively possible to adopt a setup, which includes a sliding shaft S and a coupling shaft 70. The sliding shaft S, which is cylindrical and projects upward, is disposed at a center of the uppermost center core 42, which does not have a center hole 42d. The coupling shaft 70 is adapted to slide relative to the sliding shaft S. In this connection, the coupling shaft 70 has a portion, which is similar to an upper end portion (ball holding portion 44d) separated from the coupling shaft 44 shown in the embodiment described above. Under this portion the coupling shaft 70 further has a sliding portion 71 and a spring holding portion 72. The sliding portion 71 is like a cylinder with a bottom, into which the sliding shaft S is slidably inserted. The spring holding portion 72, which is similar to the spring holding portion 44c shown in the embodiment described above, is formed around the sliding portion 71. Because this setup does not require a center hole 42d made by burring for center cores 42 except for a lowermost center core 42, it may render fabrication easier. However, because it is necessary to prepare three types of center cores 42, one type coupled with a sliding shaft S, one type without a center hole 42d and the other type with a center hole 42d, it may be preferable to select the embodiment described above.

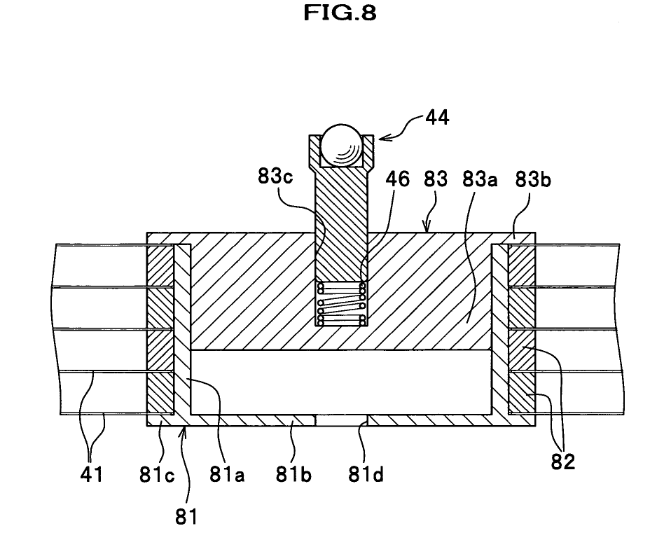

Although the embodiment described above employs a setup of stacked center cores 42 for a rotational member, it is alternative possible to adopt another setup. For example, it is possible to adopt a rotational member as shown in FIG. 8, which includes a hub 81, a spacer ring 82 and a damper 83. The hub 81, which is like a cylinder with a bottom made of magnetic material, includes a cylinder 81a, a bottom 81b formed at a lower end of the cylinder 81a and a flange 81c which externally extends from an external circumference of the bottom 81b. The bottom 81b has a spindle hole 81d, through which a spindle of magnetic disk drive is inserted. A spacer ring 82 is a ring-shaped member disposed between adjacent magnetic disk media 41 so as to space them with a predetermined distance. The damper 83 has a mating portion 83a which mates with an inner surface of the cylinder 81a of the hub 81, and a flange 83b which extends from an upper end portion of the mating portion 83a. Magnetic disk media 41 and spacer rings 82 are mounted about the cylinder 81a of the hub 81 one by one. Subsequently, the damper 83 is mated with the cylinder 81a. In this way, the magnetic disk media 41 are supported between the flange 81c and the flange 83b so that any adjacent magnetic disk media 41a are spaced with the predetermined distance.

In this setup described above, a magnetic disk medium 41 is secured to a spacer ring 82 so as to prevent their rotational displacement. Furthermore, uppermost and lowermost magnetic disk media 41 are secured to the flange 83b of the damper 83 and the flange 81c of the hub 81, respectively. It may be possible to select any type of method for fixing, such as adhesion by an adhesive and pins 43b for preventing relative rotation as shown in the embodiment described above.

If the rotational member described above is selected, it may be possible to bring about similar advantages to those obtained by the embodiment described above. In this case, as shown in FIG. 8, a sliding hole 83c, which is a cylinder with a bottom, is bored in a center of the damper 83. The coupling shaft 44 (having no spring holding portion 44c), which is similar to that shown in the embodiment described above, is slidably received by the sliding hole 83c. A compression coil spring 46 is placed between a lower surface of the coupling shaft 44 and the bottom of the sliding hole 83c. However, taking into account a merit described below, it may be preferable to select the setup shown in the embodiment described above. The setup having the stacked center cores 42 according to the embodiment allows handling of an inner plate 20 (or a lower rotor 51) and a magnetic disk medium 41 (with a center core 42) as one unit during assembly, which may render assembly work easier.

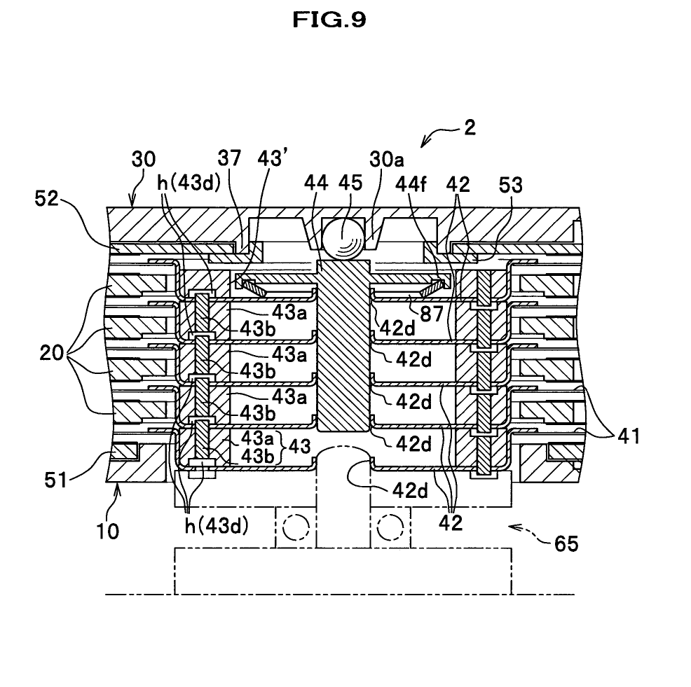

In the embodiment described above, the ball holding portion 44b having a surface recessed to form a substantially cylindrical hollow to rotatably hold the bearing ball 45 is formed on the coupling shaft 44, but the present invention is not limited thereto. As shown in FIG. 9, a ball holding portion 30a having a surface recessed to form a substantially cylindrical hollow to rotatably hold the bearing ball 45 may be provided in the center of the inner surface of the upper plate 30. Also in this embodiment, preferably but not necessarily, a depth of the ball holding portion 30a may be larger than a radius of the bearing ball 45 and smaller than its diameter. Instead of the compression coil spring 46 used as the elastic member in the embodiment described above, for example as shown in FIG. 9, a Belleville spring 87 may be provided. In this instance, a spring holding portion 44f having a dimension corresponding to an outer diameter of the Belleville spring 87 may be provided.

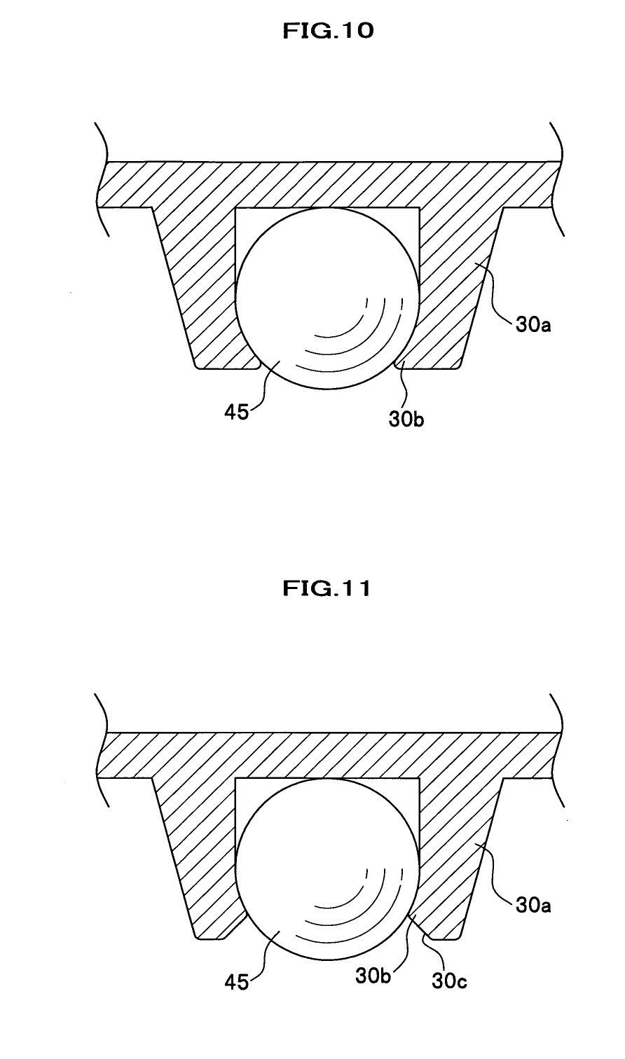

In the embodiment as shown in FIG. 9, the inside of the ball holding portion 30a is shaped in a simple cylindrical form; however, the present invention is not limited thereto, and an inwardly protruding stopper portion 30b may be formed on an inner cylindrical wall of the ball holding portion 30a, as shown in FIG. 10 for example. Since a diameter of an inscribed circle defined by an innermost edge of the stopper portion 30b is less than a diameter of the bearing ball 45, the stopper portion 30b serves to prevent the bearing ball 45 from coming away from the ball holding portion 30a during assembly of the magnetic disk cartridge 1, thus facilitating its assembly work. During assembly of the magnetic disk cartridge, to be more specific, as shown in FIG. 9, a lower plate 10 is placed at the bottom, a lower rotor 51 and inner plates on which magnetic disk media 41 are placed respectively are then stacked one by one on the lower plate 10; subsequent to stacking of a topmost one of the inner plates 20, a Belleville spring 87 and a coupling shaft 44 are set in the center hole 42d of a topmost one of the center cores 42, and an upper rotor 52 and an upper plate to which a bearing ball 45 is fitted are stacked thereon. This process presents a simplified easy approach to the assembly of the magnetic disk cartridge 1. In an embodiment where the stopper portion 30b (see FIG. 10) is not provided, the upper plate 30 may be placed at the bottom so as not to allow the bearing ball 45 to come away, and then the coupling shaft 44, Belleville spring 87, magnetic disk media 41, inner plate 20 and other components may be stacked thereon one by one, with special care or contrivance given for preventing the coupling shaft 44 from tipping during the operation of setting the coupling shaft 44 on the upper plate 30. This could, possibly but not necessarily, make the assembly work complicate or difficult in some particular instances.

The stopper portion 30b is not necessarily formed integrally with the ball holding portion 30a, and may be provided separately or attached to the ball holding portion 30a.

The stopper portion 30b as described above may, preferably but not necessarily, be rendered wider toward an edge of the opening of the ball holding portion 30a (i.e., sloping outside toward the opening of the substantially cylindrical hollow of the ball holding portion 30a). To be more specific, as shown in FIG. 11, the stopper portion 30b may, preferably but not necessarily, include a tapered portion 30c which slopes inwardly toward the bottom of the ball holding portion 30a. The tapered portion 30c thus formed in the stopper portion 30b facilitates fitting of the bearing ball 45 into the ball holding portion 30a because the bearing ball 45 in contact with the tapered portion 30c pushes the ball holding portion 30a outward to make the opening of the ball holding portion 30a wider when the bearing ball 45 is fitted into the ball holding portion 30a.

The stopper portion 30b, and optionally the tapered portion 30c, may be provided in the ball holding portion 44b formed at the end of the coupling shaft 44 provided in the aforementioned embodiment (see FIG. 5). In this alternative embodiment, as well, the bearing ball 45 once fitted in the coupling shaft 44 can be handled as a single part combined with the coupling shaft 44, so that assembly work may be facilitated.

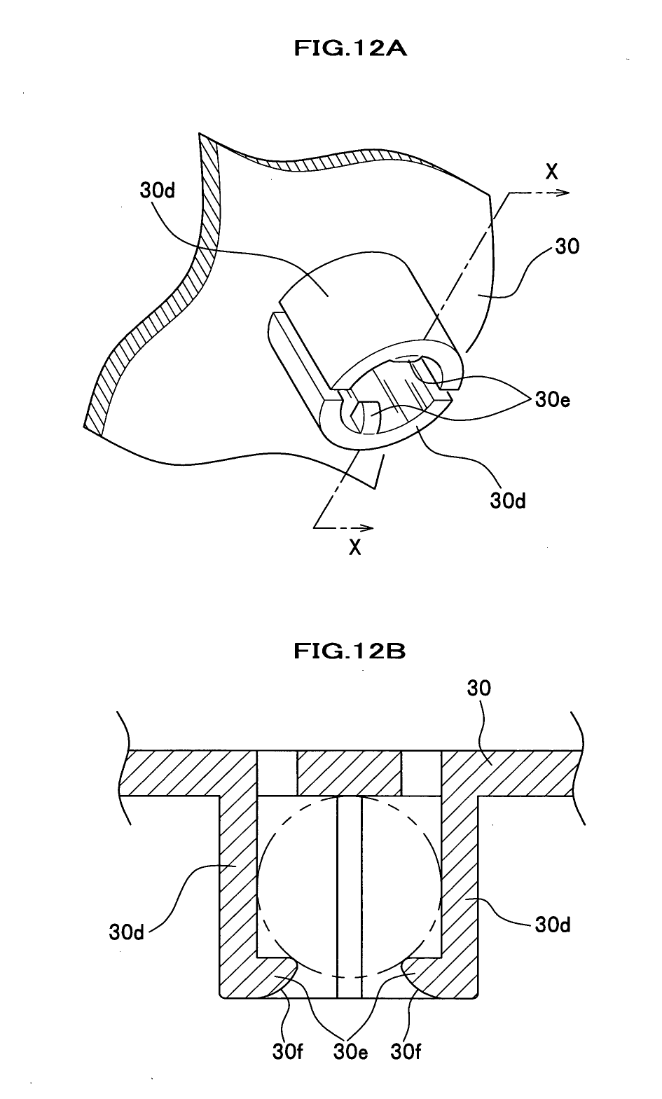

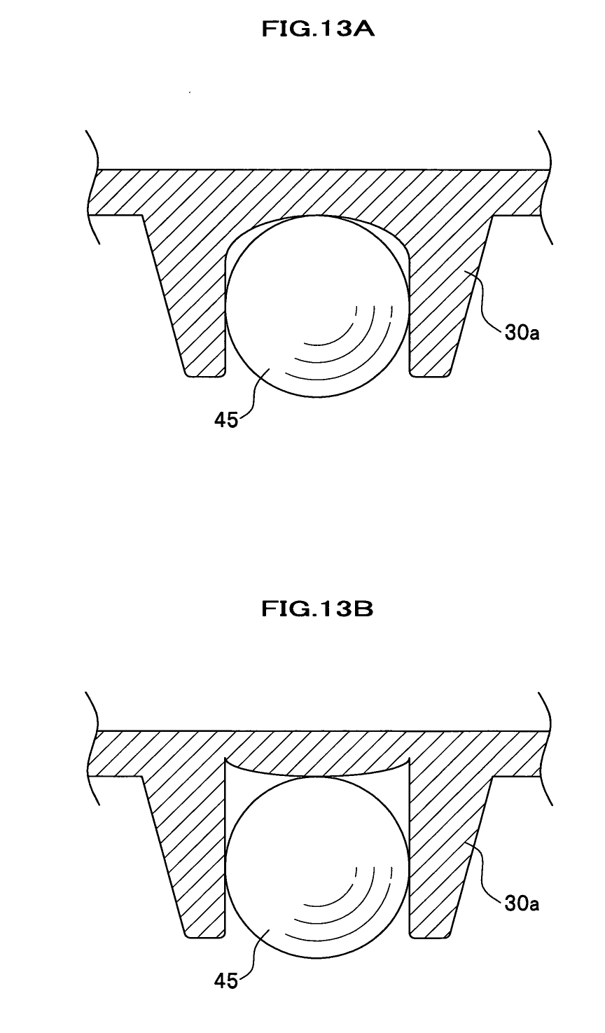

In the embodiment as illustrated in FIG. 9, the ball holding portion 30a is adapted to have a surface recessed to form a cylindrical hollow, but the present invention is not limited to this specific embodiment; that is, the hollow may be only “substantially” cylindrical. To be more specific, at least two support walls curved so as to render inner surfaces thereof cylindrical may be provided upright to form a substantially cylindrical hollow. For example, as shown in FIG. 12A, substantially half-round two support walls 30d are provided upright on the upper plate 30 with a predetermined spacing allowed between opposed edges of the support walls 30d, so that the support walls 30d may serve as a ball holding portion having inner surfaces recessed to form a substantially cylindrical hollow. In this setup, the support walls 30d each shaped like a cantilever is allowed to resiliently warp when the bearing ball 45 is fitted into the substantially cylindrical hollow formed between the support walls 30d, so that the bearing ball 45 may be fitted easily into the ball holding portion made up of the two support walls 30d.

Although the stopper portion 30b in the above embodiments is provided along the entire circumference of the inner cylindrical surface(s), the present invention is not limited to this setup. Rather, an alternative setup as shown in FIG. 12A is conceivable such that a stopper portion 30e is provided at part of each support wall 30d. This setup can also provide sufficient support for the bearing ball 45. Considering ease of removing molds used in forming the ball holding portion with stopper portion 30e integrally with the upper plate 30 by injection molding, apertures corresponding to the stopper portions 30e as illustrated in FIG. 12B may be provided.

In order to render the stopper portion 30b wider toward an edge of the opening of the ball holding portion 30a (i.e., sloping outside toward the opening), in the embodiment as illustrated in FIG. 11, the tapered portion 30c that is straight in cross section is provided in the stopper portion 30b; however, the present invention is not limited thereto. Alternatively, a tapered portion 30f that is curved in cross section as shown in FIG. 12B may be provided in the stopper portion 30e.

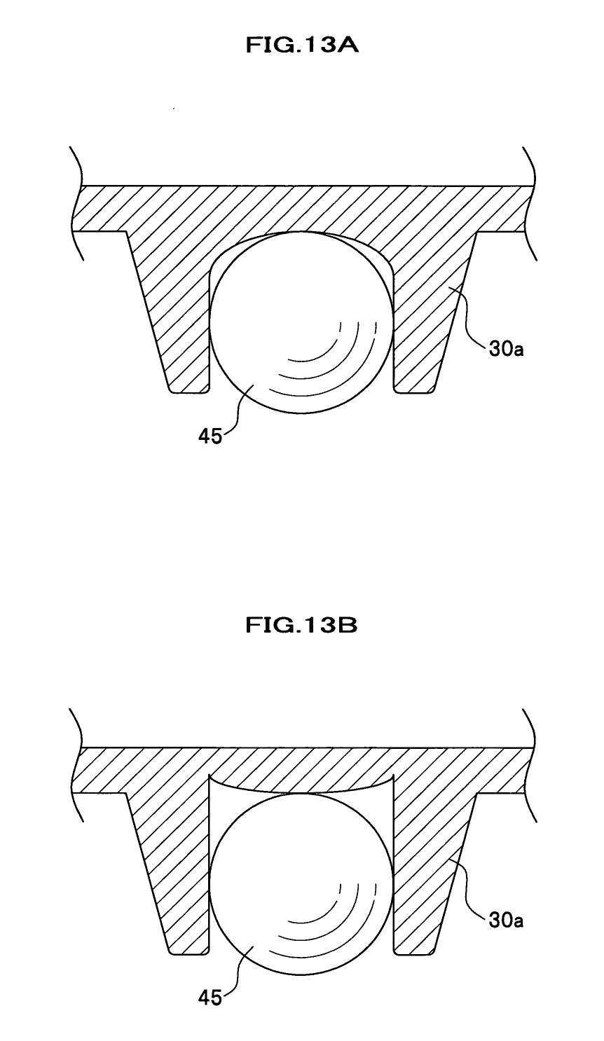

In the above embodiments, for example as shown in FIG. 9, the bottom surface of the ball holding portion 30a (i.e., bottom surface defining the substantially cylindrical hollow) is a flat surface; however, the present invention is not limited thereto. As shown in FIGS. 13A and 13B, the bottom surface may be a curved surface (e.g., a concave or recessed spherical surface as in FIG. 13A; a convex or bulged spherical surface as in FIG. 13B) of which a portion in contact with the bearing ball 45 may have a radius of curvature greater than that of the bearing ball 45.

It is contemplated that numerous modifications may be made to the exemplary embodiments of the invention without departing from the spirit and scope of the embodiments of the present invention as defined in the following claims.

What is claimed is:

1. A recording disk cartridge comprising:
a plurality of flexible recording disk media;
a cartridge case for housing the plurality of flexible recording disk media;
a rotational member for supporting the plurality of flexible recording disk media and causing the plurality of flexible recording disk media to rotate in unison within the cartridge case, the rotational member having axially opposed first and second ends, wherein the cartridge case has an opening to provide access to the first end of the rotational member from outside therethrough;
a supporting shaft fitted to a portion on an axis of rotation of the rotational member near the second end thereof, the supporting shaft being slidable along the axis of rotation of the rotational member;
a bearing ball held between an inner surface of the cartridge case and an end of the supporting shaft protruding from a second-end face of the rotational member; and
an elastic member provided between the supporting shaft and the rotational member, the elastic member being stressed to press the rotational member toward the opening of the cartridge case.

2. A recording disk cartridge according to claim 1, wherein the supporting shaft is fitted in an insertion hole provided in the rotational member.

3. A recording disk cartridge according to claim 1, wherein the supporting shaft is fitted on a sliding shaft provided in the rotational member.

4. A recording disk cartridge according to claim 1, wherein a ball holding portion having a surface recessed to form a substantially cylindrical hollow to rotatably hold the bearing ball is provided at the end of the supporting shaft.

5. A recording disk cartridge according to claim 1, wherein a ball holding portion having a surface recessed to form a substantially cylindrical hollow to rotatably hold the bearing ball is provided at the inner surface of the cartridge case.

6. A recording disk cartridge according to claim 4, wherein the ball holding portion has a depth equal to or greater than a radius of the bearing ball and less than a diameter of the bearing ball.

7. A recording disk cartridge according to claim 5, wherein the ball holding portion has a depth equal to or greater than a radius of the bearing ball and less than a diameter of the bearing ball.

8. A recording disk cartridge according to claim 4, wherein the substantially cylindrical hollow is defined with at least one inner cylindrical wall of the ball holding portion, and at least one inwardly protruding stopper portion is provided on the at least one inner cylindrical wall to prevent the bearing ball from coming away from the ball holding portion.

9. A recording disk cartridge according to claim 5, wherein the substantially cylindrical hollow is defined with at least one inner cylindrical wall of the ball holding portion, and at least one inwardly protruding stopper portion is provided on the at least one inner cylindrical wall to prevent the bearing ball from coming away from the ball holding portion.

10. A recording disk cartridge according to claim 8, wherein a diameter of an inscribed circle defined by an innermost edge of the stopper portion is less than a diameter of the bearing ball.

11. A recording disk cartridge according to claim 9, wherein a diameter of an inscribed circle defined by an innermost edge of the stopper portion is less than a diameter of the bearing ball.

12. A recording disk cartridge according to claim 10, wherein an edge of the inner cylindrical wall adjacent to an opening of the substantially cylindrical hollow is chamfered.

13. A recording disk cartridge according to claim 11, wherein an edge of the inner cylindrical wall adjacent to an opening of the substantially cylindrical hollow is chamfered.

14. A recording disk cartridge according to claim 10, wherein the stopper portion slopes outside toward an opening of the substantially cylindrical hollow.

15. A recording disk cartridge according to claim 11, wherein the stopper portion slopes outside toward an opening of the substantially cylindrical hollow.

16. A recording disk cartridge according to claim 1, wherein the elastic member is comprised of one of a compression coil spring and a Belleville spring.

17. A recording disk cartridge according to claim 1, further comprising an abrasion-resistant member provided on at least one of contact portions between the end of the supporting shaft and the bearing ball and between the bearing ball and the inner surface of the cartridge case.

18. A recording disk cartridge according to claim 1, wherein the rotational member is comprised of center cores provided respectively in the plurality of flexible recording disk media, the center cores being stacked in a manner that permits no relative rotation of the plurality of flexible recording disk media.

19. A recording disk cartridge according to claim 1, wherein the rotational member is comprised of:
a hub having a bottomed cylinder and a flange extending outward from a periphery of the bottomed cylinder;
at least one spacer ring each provided between adjacent two of the plurality of flexible recording disk media; and
a damper having a columnar portion to be fitted inside the bottomed cylinder of the hub, and a flange extending outward from a periphery of the columnar portion,
wherein the plurality of flexible recording disk media and the at least one spacer ring are held between the flanges of the hub and the clamper; and
wherein the flanges of the hub and the clamper, the plurality of flexible recording disk media, and the at least one spacer ring are fixed in a manner that permits no relative rotation of each other.

20. A recording disk cartridge according to claim 4, wherein a bottom surface defining the substantially cylindrical hollow is a curved surface of which a portion in contact with the bearing ball has a radius of curvature greater than that of the bearing ball.

21. A recording disk cartridge according to claim 5, wherein a bottom surface defining the substantially cylindrical hollow is a curved surface of which a portion in contact with the bearing ball has a radius of curvature greater than that of the bearing ball.

22. A recording disk cartridge according to claim 1, wherein the plurality of flexible recording disk media are comprised of magnetic disk media.

23. A recording disk cartridge according to claim 1, wherein the plurality of flexible recording disk media are comprised of optical disk media.
